(19) United States
(12) Patent Application Publication
(10) Pub. No.: US 2011/0314813 A1
(43) Pub. Date: Dec. 29, 2011

(54) SOLAR RECEIVER SYSTEM

(75) Inventors: Hagay Cafri, Bet-Hashmonay (IL); Zohar Goldenstein, Nes-Ziona (IL); Jacob Karni, Rehovot (IL)

(73) Assignee: YEDA RESEARCH AND DEVELOPMENT CO. LTD., Rehovot (IL)

(21) Appl. No.: 13/148,616

(22) PCT Filed: Feb. 11, 2010
(86) PCT No.: PCT/IL10/00123

§ 371 Date: Aug. 9, 2011

Related U.S. Application Data
(60) Provisional application No. 61/152,238, filed on Feb. 12, 2009.
(60) Provisional application No. 61/219,779, filed on Jun. 24, 2009.
(60) Provisional application No. 61/219,780, filed on Jun. 24, 2009.

(51) Int. Cl. F03G 6/00; F24J 2/24; F24J 2/48; F24J 2/04

(52) U.S. Cl. 60/641.8; 126/655; 126/658; 126/676

(57) ABSTRACT

A solar receiver is provided. The solar receiver may include a receiver housing with front and rear ends. The solar receiver may also include a window configured to allow radiation to pass therethrough. The window may be mounted at the front end and project within the housing. The solar receiver may also include a receiver chamber defined between the housing and the window. The receiver chamber may include a working fluid inlet for ingress of working fluid to be heated therewithin, and a working fluid outlet for egress therethrough of the heated working fluid. The solar receiver may also include a solar radiation absorber configured for absorbing the radiation and heating the working fluid thereby. The absorber may be located within the receiver chamber and may surround at least a portion of the window. The solar radiation absorber may be formed with projections.

### FIELD OF THE INVENTION

The present invention relates generally to solar energy systems and more particularly to solar energy systems with solar receivers.

### BACKGROUND OF THE INVENTION

Turbines are commonly used to produce electrical power. Typically, a working fluid, such as air, steam or any other gas, is compressed and heated before being supplied to the turbine, wherein the working fluid is expanded and some of the energy content of hot, compressed working fluid is converted to mechanical motion which is then converted to electricity by use of a generator.

In solar energy systems one device known in the art for heating the working fluid prior to entering the turbine is a solar receiver. Such a receiver utilizes solar radiation which impinges upon a solar radiation absorber within the solar receiver. The working fluid is heated by the absorber, and thereafter the working fluid transfers the heat via the turbine for producing electrical power therefrom. Additionally, heat exchangers, chemical reactions, or any other suitable apparatus or process may be used to generate electricity from the heated working fluid.

### SUMMARY OF THE INVENTION

According to one aspect of the present invention, there is provided a solar receiver comprising:
a receiver housing extending along a longitudinal axis, having front and rear ends;
a window configured to allow radiation to pass therethrough, the window being mounted at the front end and projecting within the housing;
a receiver chamber defined between the housing and the window, the receiver chamber having a working fluid inlet for ingress of working fluid to be heated therewithin, and a working fluid outlet for egress therethrough of the heated working fluid; and
a solar radiation absorber configured for absorbing the radiation and heating the working fluid thereby, the absorber being located within the receiver chamber and surrounding at least a portion of the window, the solar radiation absorber being formed with projections, each of the projections:
   being made of a foam material;
   having a longitudinal axis, wherein the longitudinal axis thereof is arranged generally perpendicularly to the window; and
   having a profile with a characteristic projectile form drag, the projectile form drag being at least 15% less than a reference form drag characterizing a projection having a square profile and oriented such that one of its edges lies substantially perpendicular to flow of working fluid.

The projectile form drag may be at least 30% less than the reference form drag.

The profile may be oblong having a longest dimension, with the projections being disposed such that the longest dimension extends generally toward the working fluid inlet.

The profile may be shaped substantially as a rhombus oriented such that a diagonal thereof is generally coplanar with the longitudinal axis of the housing. The rhombus may be right-angled (i.e., a square), or non-right-angled (i.e., a diamond shape), wherein the diagonal which is generally coplanar with the longitudinal axis of the housing is a longer diagonal of the rhombus.

The profile may be shaped substantially as an ellipse, and may be disposed such that a major axis of the ellipse is generally coplanar with the longitudinal axis of the housing.

The profile may be shaped substantially as an airfoil having a chord line, which may constitute an axis of symmetry thereof. The airfoil-shaped profile may comprise a rounded front section and a tapered rear section, which may face the working fluid inlet of the receiver chamber. The airfoil may be disposed such that the chord line is generally coplanar with the longitudinal axis of the housing.

At least some of the projections of the solar radiation absorber have profiles of shapes different from the profiles of other projections of the solar radiation absorber. The foam material may be selected from a group comprising a ceramic foam material or a metallic foam material.

The solar receiver may further comprise a radiation shield, which may be configured to allow working fluid to flow therethrough, disposed between the working fluid inlet and the receiver chamber.

The solar receiver may be designed to facilitate working fluid to flow from the working fluid inlet around and along the window prior to flowing into the absorber.

According to another aspect of the present invention, there is provided a solar receiver comprising:
a receiver housing extending along a longitudinal axis, having front and rear ends;
a window configured to allow radiation to pass therethrough, the window being mounted at the front end and projecting within the housing;
a receiver chamber defined between the housing and the window, the receiver chamber having a working fluid inlet for ingress of working fluid to be heated therewithin, and a working fluid outlet for egress therethrough of the heated working fluid; and
a solar radiation absorber configured for absorbing the radiation and heating the working fluid thereby, the absorber being located within the receiver chamber and surrounding at least a portion of the window, the solar radiation absorber being formed with projections, each of the projections:
   being made of a foam material; and
   having a longitudinal axis, wherein the longitudinal axis thereof is arranged generally perpendicularly to the window.

The foam material may be selected from a group comprising a ceramic foam material or a metallic foam material.

The solar receiver may further comprise a radiation shield, which may be configured to allow working fluid to flow therethrough, disposed between the working fluid inlet and the receiver chamber.

The solar receiver may be designed to facilitate working fluid to flow from the working fluid inlet around and along the window prior to flowing into the absorber.

According to a further aspect of the present invention, there is provided a solar receiver comprising:
a receiver housing extending along a longitudinal axis, having front and rear ends;
a window configured to allow radiation to pass therethrough, the window being mounted at the front end and projecting within the housing;
a receiver chamber defined between the housing and the window, the receiver chamber having a working fluid inlet for ingress of working fluid to be heated therewithin, and a working fluid outlet for egress therethrough of the heated working fluid; and
a solar radiation absorber configured for absorbing the radiation and heating the working fluid thereby, the absorber being located within the receiver chamber and surrounding at least a portion of the window, the solar radiation absorber being formed with projections, each of the projections:
   having a longitudinal axis, wherein the longitudinal axis thereof is arranged generally perpendicularly to the window; and
   having a profile with a characteristic projectile form drag, the projectile form drag being at least 15% less than a reference form drag characterizing a projection having a square profile and oriented such that one of its edges lies substantially perpendicular to flow of working fluid.

The projectile form drag may be at least 30% less than the reference form drag.

The profile may be oblong having a longest dimension, with the projections being disposed such that the longest dimension extends generally toward the working fluid inlet.

The profile may be shaped substantially as a rhombus oriented such that a diagonal thereof is generally coplanar with the longitudinal axis of the housing. The rhombus may be right-angled (i.e., a square), or non-right-angled (i.e., a diamond shape), wherein the diagonal which is generally coplanar with the longitudinal axis of the housing is a longer diagonal of the rhombus.

The profile may be shaped substantially as an ellipse, and may be disposed such that a major axis of the ellipse is generally coplanar with the longitudinal axis of the housing.

The profile may be shaped substantially as an airfoil having a chord line, which may constitute an axis of symmetry thereof. The airfoil-shaped profile may comprise a rounded front section and a tapered rear section, which may face the working fluid inlet of the receiver chamber. The airfoil may be disposed such that the chord line is generally coplanar with the longitudinal axis of the housing.

At least some of the projections of the solar radiation absorber have profiles of shapes different from the profiles of other projections of the solar radiation absorber. The solar receiver may further comprise a radiation shield, which may be configured to allow working fluid to flow therethrough, disposed between the working fluid inlet and the receiver chamber.

The solar receiver may be designed to facilitate working fluid to flow from the working fluid inlet around and along the window prior to flowing into the absorber.

According to a still further aspect of the present invention, there is provided a solar receiver system comprising:
a solar receiver according to any one of above aspects; and
a turbine operative to receive the working fluid from the working fluid outlet and to generate electricity therefrom.

According to a still further aspect of the present invention, there is provided a solar radiation absorber for use in a solar receiver, the solar radiation absorber comprising a receiver housing and a window mounted thereto and projecting therewithin, the solar radiation absorber being configured for absorbing radiation and heating a working fluid thereby, the solar radiation absorber being formed with projections, each of the projections:
being made of a foam material;
having a longitudinal axis arranged generally perpendicularly to the window; and
having a profile with a characteristic projectile form drag, the projectile form drag being at least 15% less than a reference form drag characterizing a projection having a square profile and oriented such that one of its edges lies substantially perpendicular to flow of working fluid.

### BRIEF DESCRIPTION OF THE DRAWINGS

The present subject matter will be understood and appreciated more fully from the following detailed description, taken in conjunction with the drawings in which:

FIG. 1 is a perspective view of a solar receiver;

FIGS. 2A and 2B are each a sectional view of the receiver illustrated in FIG. 1;

FIGS. 3A through 3C are perspective views of examples of absorber projections of a solar absorber of the solar receiver illustrated in FIGS. 1 through 2B; and

FIG. 4 schematically illustrates the operation of the solar receiver illustrated in FIGS. 1 through 2B.

### DETAILED DESCRIPTION

In the following description, various aspects of the present subject matter will be described. For purposes of explanation, specific configurations and details are set forth in order to provide a thorough understanding of the present subject matter. However, it will also be apparent to one skilled in the art that the present subject matter may be practiced without the specific details presented herein. Furthermore, well known features may be omitted or simplified in order not to obscure the description of the subject matter.

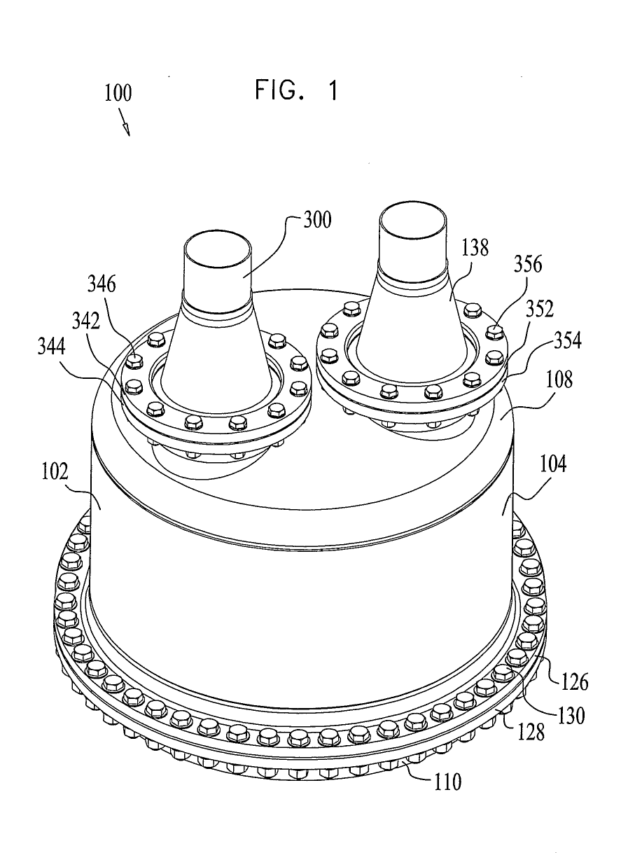

As seen in FIG. 1, a solar receiver 100 comprises a receiver housing 102 formed of stainless steel or any other suitable material. Housing 102 may be configured of a generally cylindrical main portion 104 and being formed with a top portion 108 at a rear end thereof, and a bottom portion 110 at a front end thereof. Housing 102 may be shaped in any suitable form.

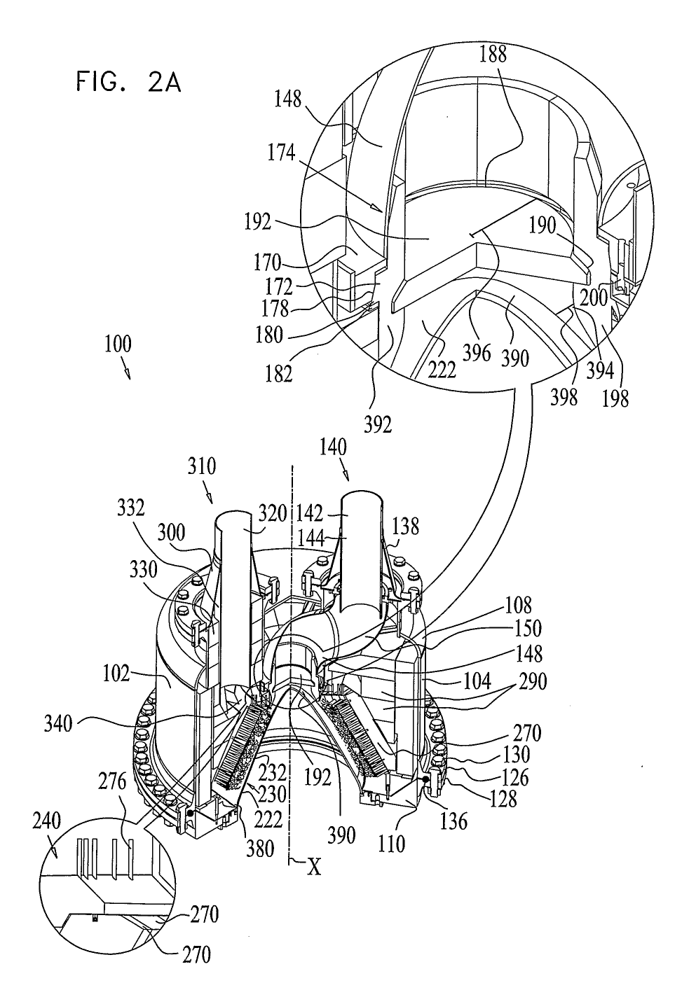

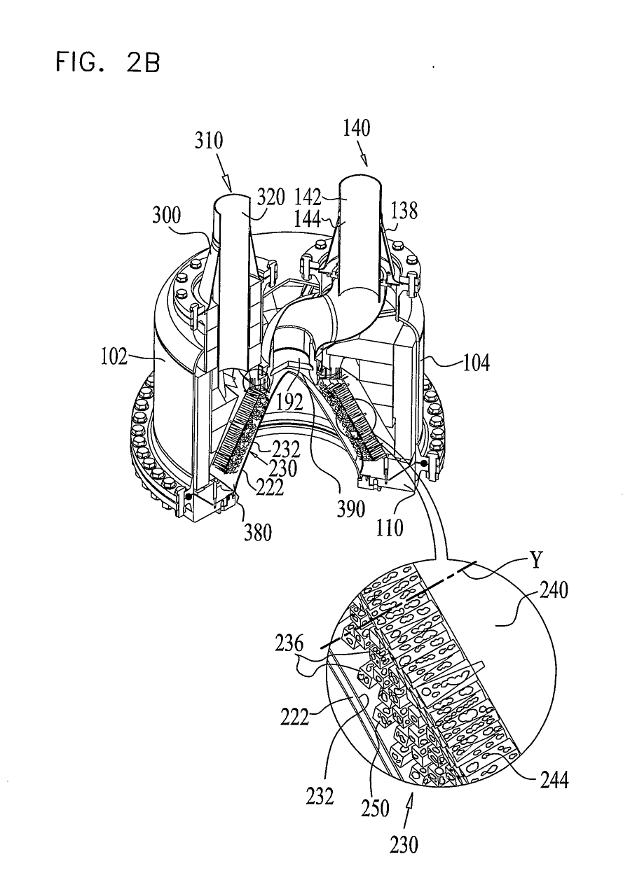

As seen in FIG. 2A, main portion 104 is engaged with top portion 108 by any suitable means, such as by welding. Main portion 104 is engaged with bottom portion 110 by any suitable means, such as by a peripheral protrusion 126, protruding from main portion 104, mounted to a peripheral protrusion 128, protruding from bottom portion 110, by screws 130. An O-ring 136 may be disposed between protrusions 126 and 128 and is provided to ensure the engagement of main portion 104 with bottom portion 110 is a tight sealed engagement.

An inlet conduit housing 138 of an inlet conduit assembly 140 protrudes from top portion 108. An inlet conduit 142 is formed of a generally cylindrical portion 144 which is partially disposed within inlet conduit housing 138. A generally central inlet conduit portion 148 is disposed within main portion 104 of receiver housing 102 and is connected to cylindrical portion 144 by a generally angular portion 150. Inlet conduit 142 may be formed of stainless steel or any other suitable material.

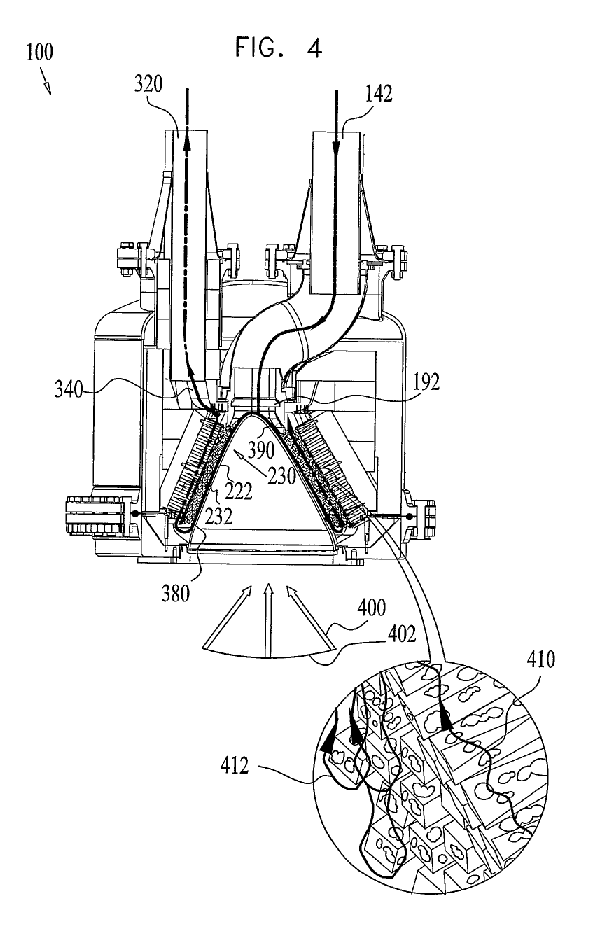

As seen in the inset in FIG. 2A, central inlet conduit portion 148 defines on a bottom portion thereof a peripheral protrusion 170 which presses upon a central radiation shield enclosure 172 of a radiation shield assembly 174 at an inclined surface 178 thereof. Protrusion 170 may be formed of stainless steel or any other suitable material. Enclosure 172 may be provided for thermal insulation of high-temperature working fluid flowing through radiation to shield assembly 174, as will be further described hereinbelow with reference to FIG. 4. Enclosure 172 may be formed of a ceramic or any other suitable material. A ridge 180, defined by enclosure 172, is seated on a peripheral ring support 182 formed of stainless steel or any other suitable material.

Enclosure 172 defines an annular recess 188 in a middle portion 190 thereof. A radiation shield 192 is seated within recess 188 and may be formed of any suitable material, such as ceramics or metals adopted to withstand relatively high temperatures. Radiation shield 192 may be formed of tubes, pins or any perforated structure, for example, so as to allow working fluid to flow therethrough.

An annular insulating element 198 may be provided to surround peripheral protrusion 170 and a portion of enclosure 172 and may be connected to peripheral protrusion 170 and ring support 182 via screws 200 inserted therein or by any other suitable means.

Radiation shield 192 may be provided so as to shield the inlet conduit assembly 140 from solar radiation entering receiver 100 via a window 222, defining a longitudinal axis X which is generally coincident with a longitudinal axis of the receiver housing 102, while allowing the working fluid to flow from inlet conduit 142 via perforation in the radiation shield 192 on to window 222.

It is noted that the radiation shield 192 may be replaced by any other suitable means for shielding the inlet conduit assembly 140 from solar radiation.

Window 222 is mounted at the front end of the housing 102, and is disposed so as to project therewithin. Window 222 is designed so as to allow solar radiation to impinge thereon and penetrate therethrough, as will be further described hereinbelow with reference to FIG. 4.

A receiver chamber is defined between the window 222 and the housing 102. The termination of the inlet conduit 142 constitutes a working fluid inlet of the receiver chamber, and an outlet conduit 320 (described below) constitutes a working fluid outlet of the receiver chamber.

Window 222 may be shaped, e.g., as a portion of a paraboloid of revolution, as a portion of a hyperbolic paraboloid, or as any suitable geometric configuration defining a streamlined contour wherein there is no profile transition from one geometric shape to the other. The streamlined contour minimizes turbulent flow of the working fluid flowing along the window 222 and minimizes reflection losses of incoming solar radiation therethrough. Additionally, the streamlined contour minimizes tensile stresses on the window 222 caused, e.g., by profile transitions, and allows for increased accuracy in production thereof.

It is noted that window 222 may be shaped in any suitable conical-like or frusto-conical-like configuration or a geometric configuration defining a streamlined contour wherein there is a profile transition from one geometric shape to the other or any other suitable form so as to allow solar radiation to impinge thereupon and working fluid to flow therearound. Window 222 may be formed of any suitable material able to withstand relatively high temperatures and admit solar radiation therein. For example, window 222 may be formed of fused quartz.

Window 222 may be mounted to housing 102 by any suitable means.

A solar radiation absorber 230 is disposed around and along at least a portion of an internal surface 232 of window 222.

Turning to FIG. 2B it is seen that the solar radiation absorber 230 may be formed comprising a plurality of projections 236 protruding from an insulating support element 240 formed of any suitable insulating material.

The projections 236 are generally radially arranged to surround window 222 at internal surface 232 thereof.

Projections 236 may be formed of any suitable material allowing solar radiation and a working fluid to pass therethrough. The projections 236 may be formed of a perforated material thereby defining perforations 244 therein. The perforated material may be any suitable material, such a metallic or ceramic foam material comprising a network of ceramic strings defining pores therebetween. Perforations 244 increase the area of the projections 236 available for absorbing radiation. The projection material may be capable of withstanding relatively high temperatures.

Each projection 236 extends along a longitudinal axis Y thereof, which is generally arranged perpendicularly to internal surface 232 of window 222. Projections 236 may be formed in any suitable configuration and/or they may be formed having any suitable profile (i.e., cross-sectional shape in a plane perpendicular to the longitudinal axis Y of the projection 236), such as a streamlined profile. (It will be appreciated that while several of the projections 236 illustrated in the inset in FIG. 2B are truncated, this is due to the sectioning plane intersecting them, and not due to a degenerate shape thereof. However, providing such shapes may still be within the scope of the present invention.). Such a profile is designed to a have a low coefficient of drag under working conditions of the solar receiver 100. In general, the contribution of the form drag of a projection 236 having a streamlined profile to the overall drag coefficient is substantially less, for example at least 15%-30% less, than that of a projection having a square profile and oriented such that one of its edges lies substantially perpendicular to flow of working fluid.

It will be appreciated that the overall drag coefficient of the projection is based on a number of factors:
the Reynolds number, which may be expressed as a function of the velocity, viscosity, and density of the working fluid, as well as a characteristic dimension of the projection;
spacing between the projections;
the construction of the surface of the projection, specifically its porosity; and
the form drag, which depends on the profile and orientation of the projection with respect to fluid flow.

It will be appreciated that the form drag can be determined experimentally, as is known in the art.

In general, the projection 236 may have a cross-section which is generally oblong in profile, and be arranged such that its longest dimension is generally parallel to the direction of flow of working fluid during use of the receiver 100 (i.e., an axis along the longer dimension extends generally toward the working fluid inlet of the receiver chamber (as will be described below with reference to FIG. 4, the working fluid is heated by the projections 236 as it takes a path towards the working fluid inlet on its way to the working fluid outlet; according to designs wherein the working fluid is heated along a different path, the longest dimension is arranged such that it extends in the appropriate direction); in general such axis would be substantially coplanar with the axis X of the window 222).

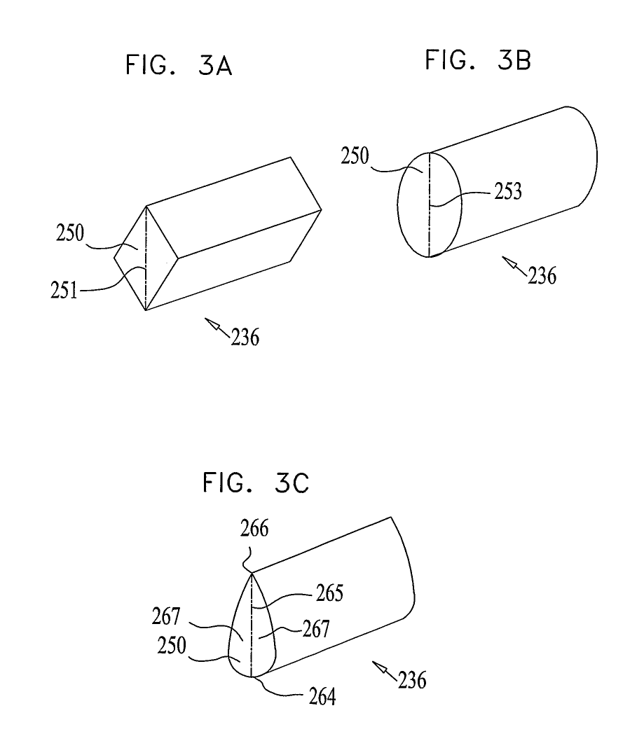

As seen in FIG. 3A, the cross-section 250 of each of the projections 236 may be shaped substantially as a rhombus, either being right-angled (wherein the vertices thereof form right angles) or non right-angled (i.e., a diamond profile) which may be disposed such that its longer diagonal 251 is generally parallel to the direction of flow of working fluid, i.e., substantially coplanar with the axis X of the window 222, i.e., it extends generally toward the working fluid inlet of the receiver chamber. (It will be appreciated that use of the term “rhombus” herein is based on its broadest definition, including shapes which may also be described with the term “square”.)

As illustrated in FIG. 3B, the cross-section 250 of each of the projections 236 may be shaped substantially as an ellipse, which may be disposed such that its major axis 253 is generally parallel to the direction of flow of working fluid, i.e., substantially coplanar with the axis X of the window 222, i.e., it extends generally toward the working fluid inlet of the receiver chamber, for example.

As illustrated in FIG. 3C, the projections 236 may be formed with a cross-section 250 having the general profile of an airfoil, i.e., wing-like. The cross-section 250 is generally formed with a contour defining a rounded front section 264, constituting the leading edge of the airfoil, gradually curving to a tapered rear section 266, constituting the trailing edge of the airfoil, thereby minimizing resistance to the flow of a fluid therearound. It will be appreciated that some or all of the projections 236 may be arranged such that the front section 264 faces oncoming working fluid, i.e., it faces away from the working fluid inlet of the receiver chamber (i.e., the rear section 266 faces the working fluid inlet).

The cross-section 250 may be formed as a symmetric airfoil, i.e., having no camber (i.e., asymmetry) between two halves 267 thereof separated by a chord line 265 thereof (i.e., the chord line constitutes an axis of symmetry). Such a projection 236 may be arranged such that its angle of attack in relation to incoming working fluid is substantially zero, i.e., the chord line 265 thereof being substantially coplanar with the axis X of the window 222, i.e., it extends generally toward the working fluid inlet of the receiver chamber.

It will be appreciated that the solar radiation absorber 230 may comprise projections of different cross-sections.

Support element 240 may be formed of a plurality of substrates 270 annually arranged around internal surface 232 of window 222 and pressed against each other so as to form support element 240. Pins or any other means to prevent dislocation of substrates 270 may be provided. For example, longitudinal pins 276 may be inserted within substrates 270. It is noted that substrates 270 may adhere to each other in any suitable manner, such as by an adhesive, for example.

A plurality of annular thermal insulating elements 290 may be disposed within receiver 100. Thermal insulating elements 290 may be formed of a ceramic material or any other suitable material and are provided to prevent solar radiation emission into housing 102. It is appreciated that thermal insulating elements 290 may be configured in any suitable manner, such as in the form of a single element, for example.

An outlet conduit housing 300 of an outlet conduit assembly 310 protrudes from top portion 108. An outlet conduit 320 is formed of a generally cylindrical portion which is partially disposed within outlet conduit housing 300 and partially disposed within top portion 108. Outlet conduit housing 300 and outlet conduit 320 may be formed of stainless steel or any other suitable material. Outlet conduit assembly 310 is provided for egress of a working fluid from receiver 100.

A plurality of thermal insulating elements 330 may be disposed around and along an outer surface 332 of outlet conduit 320 and are provided to prevent heating of receiver housing top portion 108 by relatively high temperature working fluid flowing through outlet conduit 320. Thermal insulating elements 330 may be formed of a ceramic material or any other suitable material. Outlet conduit 320 is in fluid communication with an outlet fluid chamber 340 defined by the vicinity formed between insulating element 198, absorber 230 and insulating elements 290.

Outlet conduit housing 300 may include a first flange 342 protruding therefrom. First flange 342 may be mounted to a second flange 344 protruding from top portion 108 via screws 346 inserted therein. First flange 342 is provided as an interface with a solar energy system component, such as a turbine (not shown).

Inlet conduit housing 138 may include a first flange 352 protruding therefrom. First flange 352 may be mounted to a second flange 354 protruding from top portion 108 via screws 356 inserted therein. First flange 352 is provided as an interface with a solar energy system component, such as a compressor (not shown).

It is noted that first flanges 342, 352 of the outlet and inlet conduit housings 300, 138 may be replaced with any other suitable element or elements for providing an interface with the solar energy system component.

As seen in FIG. 4, a working fluid, such as air, for example, is introduced into inlet conduit 142 of receiver 100. Working fluid may flow in, following compression within a compressor (not shown).

Working fluid flows from inlet conduit 142 via radiation shield 192 on to the internal surface 232 of window 222. At a base portion 380 of window 222 the working fluid expands into absorber 230.

It is noted that the incoming working fluid from inlet conduit 142 flows via radiation shield 192 initially to the internal surface 232 of window 222 prior to flowing into the absorber 230 due to the decrease of the surface area of the working fluid flow from the radiation shield 192 to a top portion 390 of window 222. As seen in the inset in FIG. 2A, the surface area of the radiation shield 192 is substantially larger than the surface area defined by the area between a bottom portion 392 of enclosure 172 and top portion 390 of window 222. This area is designated by reference numeral 394. The difference in the surface areas is illustrated by the difference in a radius 396 of the radiation shield surface area and a radius 398 of surface area 394. Thus, as the surface area of the working fluid flow decreases from the radiation shield surface area to surface area 394 the velocity of the working fluid consequentially increases, thereby urging the working fluid to flow along window 222 from top portion 390 to base portion 380 thereof. At base portion 380 the velocity of the working fluid decreases thus allowing the working fluid to expand into absorber 230. The initial flow of the working fluid along window 222 provides for cooling of the window 222 subjected to relatively high temperatures due to admission of solar radiation therethrough.

Solar radiation, designated by reference numeral 400, is admitted into absorber 230 via window 222 typically following concentration by a concentrator 402 of the solar energy system. It is noted that concentrator 402 is not shown to scale.

Solar radiation 400 passes window 222 and thereafter readily penetrates some of the material of the absorber 230, e.g., through projection 236 via perforations 244.

As mentioned above, the longitudinal axis Y of each projection 236 is generally arranged perpendicularly to internal surface 232 of window 222. This allows the working fluid to flow along absorber 230 generally perpendicular to incoming solar radiation 400 so as to ensure maximal heat transfer of heat absorbed within projection 236 to working fluid flowing therethrough. This working fluid path 410 is illustrated in the inset of FIG. 4. Additionally, the working fluid flows around the bars and is illustrated by working fluid path 412.

The solar radiation absorbed within projections 236 is emitted as heat to working fluid flowing within the absorber 230 thereby heating the working fluid therein.

Heated working fluid flows from absorber 230 to outlet fluid chamber 340 and exits receiver 100 via outlet conduit 320. Thereafter heated working fluid may be introduced into a turbine (not shown) for generation of electrical energy therefrom.

It is appreciated that the solar receiver 100 may be incorporated in solar thermal systems such as on-axis tracking solar thermal systems, or off-axis tracking solar thermal systems. The on-axis tracking solar system is known in the art as a solar system wherein the target, e.g., a solar receiver, is always kept on, a center-line formed between a solar reflector (or reflectors) and the sun, therefore the target location continuously changes to follow the sun movement. Examples of on-axis tracking solar systems include parabolic dish reflectors/concentrators and Fresnel lens concentrators. In off-axis tracking solar systems the target (e.g., solar receiver) may be stationary or move, but generally not kept in the center-line formed between the reflector (or reflectors) and the sun. Examples of off-axis tracking solar systems include central solar receivers such as solar towers.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1.-42. (canceled)

43. A solar receiver comprising:
a receiver housing extending along a longitudinal axis, having front and rear ends;
a window configured to allow radiation to pass therethrough, the window being mounted at the front end and projecting within the housing;
a receiver chamber defined between the housing and the window, the receiver chamber having a working fluid inlet for ingress of working fluid to be heated therewithin, and a working fluid outlet for egress therethrough of the heated working fluid; and
a solar radiation absorber configured for absorbing the radiation and heating the working fluid thereby, the solar radiation absorber being located within the receiver chamber and surrounding at least a portion of the window, the solar radiation absorber being formed with projections, each of the projections
being made of a foam material,
having a longitudinal axis, wherein the longitudinal axis thereof is arranged generally perpendicularly to the window, and
having a profile with a characteristic projectile form drag, the projectile form drag being at least 15% less than a reference form drag characterizing a projection having a square profile and oriented such that one of its edges lies substantially perpendicular to flow of working fluid.

44. The solar receiver according to claim 43, wherein the projectile form drag is at least 30% less than the reference form drag.

45. The solar receiver according to claim 43, wherein the profile is oblong having a longest dimension, the projections being disposed such that the longest dimension extends generally toward the working fluid inlet.

46. The solar receiver according to claim 43, wherein the profile is shaped substantially as a rhombus oriented such that a diagonal thereof is generally coplanar with the longitudinal axis of the housing.

47. The solar receiver according to claim 46, wherein the rhombus is right-angled.

48. The solar receiver according to claim 46, wherein the diagonal is a longer diagonal of the rhombus.

49. The solar receiver according to claim 43, wherein the profile is shaped substantially as an ellipse.

50. The solar receiver according to claim 49, the projections being disposed such that a major axis of the ellipse is generally coplanar with the longitudinal axis of the housing.

51. The solar receiver according to claim 43, wherein the profile is shaped substantially as an airfoil having a chord line.

52. The solar receiver according to claim 51, wherein the profile comprises a rounded front section and a tapered rear section.

53. The solar receiver according to claim 52, wherein the rear section generally faces the working fluid inlet of the receiver chamber.

54. The solar receiver according to claim 51, wherein the chord line constitutes an axis of symmetry thereof.

55. The solar receiver according to claim 51, wherein the airfoil is disposed such that the chord line is generally coplanar with the longitudinal axis of the housing.

56. The solar receiver according to claim 43, wherein at least some of the projections of the solar radiation absorber have profiles of shapes different from the profiles of other projections of the solar radiation absorber.

57. The solar receiver according to claim 43, wherein the foam material is selected from a group consisting of a ceramic foam material and a metallic foam material.

58. The solar receiver according to claim 43, further comprising a radiation shield disposed between the working fluid inlet and the receiver chamber.

59. The solar receiver according to claim 58, wherein the radiation shield is configured to allow working fluid to flow therethrough.

60. The solar receiver according to claim 43, being designed to facilitate working fluid to flow from the working fluid inlet around and along the window prior to flowing into the absorber.

61. A solar receiver system comprising:
a solar receiver according to claim 43; and
a turbine operative to receive the working fluid from the working fluid outlet and to generate electricity therefrom.

62. A solar radiation absorber for use in a solar receiver, the solar radiation absorber comprising: a receiver housing and a window mounted thereto and projecting therewithin, the solar radiation absorber being configured for absorbing radiation and heating a working fluid thereby, the solar radiation absorber being formed with projections, each of the projections
being made of a foam material,
having a longitudinal axis arranged generally perpendicularly to the window, and
having a profile with a characteristic projectile form drag, the projectile form drag being at least 15% less than a reference form drag characterizing a projection having a square profile and oriented such that one of its edges lies substantially perpendicular to flow of working fluid.
